(19) United States
(12) Patent Application Publication
(10) Pub. No.: US 2013/0284601 A1
(43) Pub. Date: Oct. 31, 2013

(54) METHOD FOR PREPARING AN ANION EXCHANGE MEMBRANE WITH ION EXCHANGE GROUPS AND AN APPARATUS FOR REMOVAL OF IONS

(71) Applicants: Albert Van Der Wal, Oegstgeest (NL); Piotr Edward Dlugolecki, Gdansk (PL); Hank Robert Reinhoudt, Wassenaar (NL); Michel Henri Chretien Joseph Van Houtem, Eindhoven (NL); Henricus Marie Janssen, Eindhoven (NL)

(72) Inventors: Albert Van Der Wal, Oegstgeest (NL); Piotr Edward Dlugolecki, Gdansk (PL); Hank Robert Reinhoudt, Wassenaar (NL); Michel Henri Chretien Joseph Van Houtem, Eindhoven (NL); Henricus Marie Janssen, Eindhoven (NL)

(73) Assignee: VOLTEA B.V., Sassenheim (NL)

(21) Appl. No.: 13/847,966

(22) Filed: Mar. 20, 2013

(30) Foreign Application Priority Data
Mar. 21, 2012 (NL) 2008516

(51) Int. Cl. B01J 41/14; C02F 1/469

(52) U.S. Cl. CPC B01J 41/14; C02F 1/4691
USPC 204/630; 521/27

(57) ABSTRACT

A method of preparing an anion exchange membrane with anion exchange groups. The method includes polymerizing a first monomer with a functional group selected from the pyridine derivatives with a second monomer selected from the benzene derivatives, such as styrene, to form a copolymer. The copolymer may be crosslinked with a crosslinker. The functional group of the copolymer may be functionalized to an anion exchange group.

This application claims priority from Netherlands Patent Application No. NL2008516, filed Mar. 21, 2012, which is incorporated herein in its entirety by reference.

### FIELD

The present invention relates to preparing an anion exchange membrane with anion exchange groups.

### BACKGROUND

In recent years one has become increasingly aware of the impact of human activities on the environment and the negative consequences this may have. Ways to reduce, reuse and recycle resources are becoming more important. In particular, clean water is becoming a scarce commodity. Therefore, various methods and devices for purifying water have been published.

A method for water purification is by capacitive deionization, using an apparatus having a flow through capacitor (FTC) to remove ions in water. The FTC functions as an electrically regenerable cell for capacitive deionization. By charging electrodes, ions are removed from an electrolyte and are held in electric double layers at the electrodes. The electrodes can be (partially) electrically regenerated to desorb such previously removed ions without adding chemicals.

The apparatus for removal of ions comprises one or more pairs of spaced apart electrodes (a cathode and an anode) and a spacer, separating the electrodes and allowing water to flow between the electrodes. The electrodes are provided with current collectors or backing layers and a high surface area material, such as e.g. carbon, which may be used to store removed ions. The current collectors may be in direct contact with the high surface area material. Current collectors are electrically conductive and transport charge in and out of the electrodes and into the high surface area material.

A charge barrier may be placed adjacent to an electrode of the flow-through capacitor. The term charge barrier refers to a layer of material which is permeable or semi-permeable for ions and is capable of holding an electric charge. Ions with opposite charge as the charge barrier charge can pass the charge barrier material, whereas ions of similar charge as the charge of the charge barrier cannot pass the charge barrier material. Ions of similar charge as the charge barrier material are therefore contained or trapped either in e.g. the electrode compartment and/or in the spacer compartment. The charge barrier is often made from an ion exchange material provided in a membrane. A membrane provided with ion exchange material may allow an increase in ionic efficiency, which in turn allows energy efficient ion removal.

### SUMMARY

It is, for example, an object of the invention to provide a method for preparing an anion exchange membrane, the method comprising reacting a first monomer with a functional group with a second monomer to form a copolymer, and reacting the copolymer with a crosslinker to crosslink the copolymer to form at least part of the membrane.

According to an embodiment, there is provided a method of preparing an anion exchange membrane with anion exchange groups, the method comprising:

reacting at least a first monomer comprising vinyl-pyridine with a pyridine derivative as a functional group with at least a second monomer comprising styrene to form a substantial linear copolymer; and

reacting the copolymer with a crosslinker, the crosslinker reacting with the pyridine derivative group of the copolymer crosslinking the copolymer and forming the anion exchange groups.

The yield of reacting the vinyl-pyridine with the styrene is relatively high making the reaction producing the substantially linear copolymer favorable.

According to an embodiment there is provided an apparatus to remove ions, the apparatus comprising: a first and second electrode; and an anion exchange membrane on the first electrode, wherein the anion exchange membrane is obtained by crosslinking a substantially linear copolymer according to a method described herein.

### BRIEF DESCRIPTION OF THE FIGURES

Embodiments of the invention will be described, by way of example only, with reference to the accompanying schematic drawings in which corresponding reference symbols indicate corresponding parts, and in which:

FIG. 1 shows a schematic cross-section of an apparatus to remove ions;

FIG. 2a shows a detail enlargement of the stack 3 of FIG. 1;

FIG. 2b shows a detail of FIG. 1;

FIG. 3 shows an electrode comprising an anion exchange membrane according to an embodiment; and

FIG. 4 shows a voltage profile of a stack comprising a membrane according to an embodiment after 4 h of operation.

### DETAILED DESCRIPTION

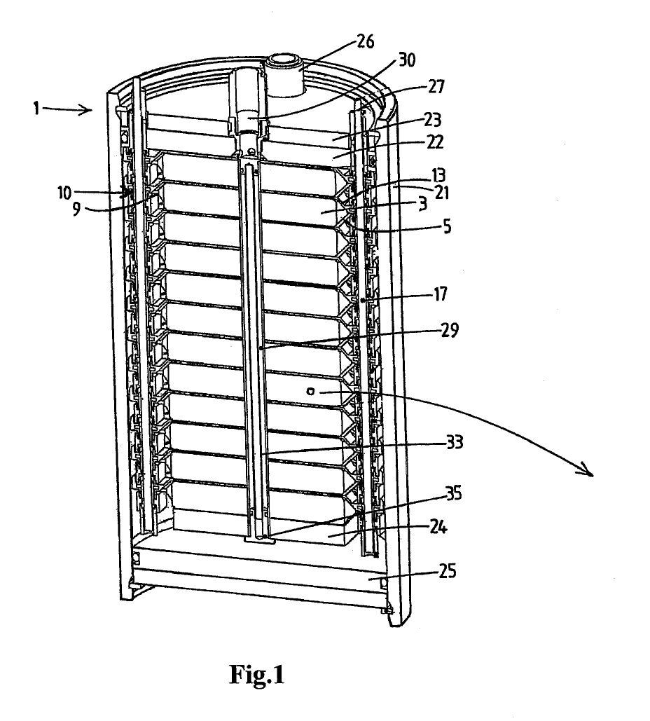

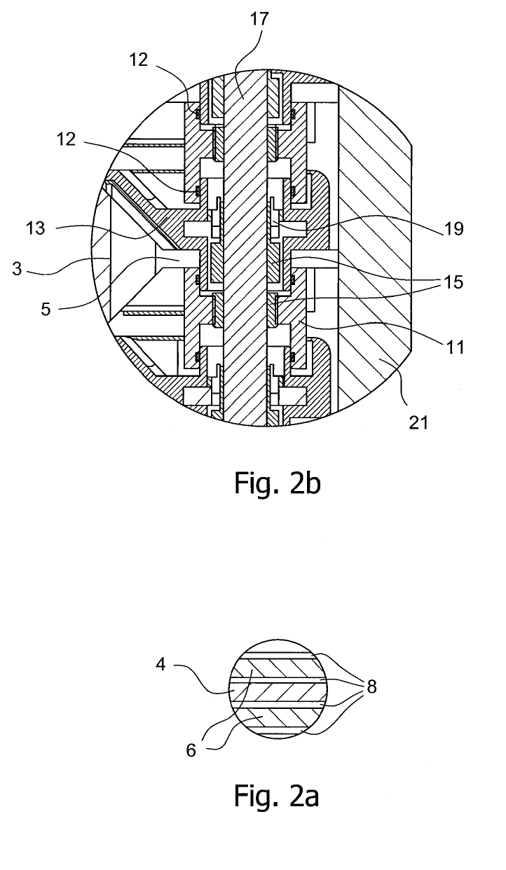

FIG. 1 shows a schematic cross-section of an apparatus to remove ions 1 produced according to, for example, a method according to an embodiment of the invention, with a part of the housing removed. In the example the apparatus may comprise twelve flow through capacitor stacks 3. The flow through capacitor stack 3 may comprise repeating units of a first electrode 4 (see FIG. 2a, which is an enlargement of a stack), a spacer 8, and a second electrode 6. The first electrode 4 may comprise one or more first current collectors 5, which may be bundled together with a first connector 11 (see FIG. 2b, which is a partial enlargement of FIG. 1). The first connector 11 may be used to clamp first current collectors 5 together. The second electrode 6 may comprise one or more second current collectors 9, which may equally be bundled together on the other side of the apparatus with a second connector 10. The second connector 10 may be used to clamp second current collectors 9 together.

The current collectors 5, 9 and the connectors 11, 10 may be made of the same material e.g. carbon (e.g. graphite) to lower the electrical resistivity between the current collectors 5, 9 and the connectors 11, 10. The first connector 11 may have an insert 15 e.g. made from a metal, such as copper. The insert 15 may be screwed in the first connector 11 so as to help assure low electrical resistivity between the insert 15 and the first connector 11. The power terminal 27 is a construction that is connected to both the power supply and one or more connectors 10, 11. The power terminal 27 may be fixed into the upper and/or bottom part 22, 24 and/or any other part of the housing. The power terminal 27 may have a rail e.g. rod 17 made of, for example, metal e.g. copper to electrically connect the first connector(s) 11 via the insert(s) 15 to a power source (not shown). The first connector 11 and the insert 15 may have an opening for the rod 17. The insert 15 and the rod 17 may be shielded from the water inside the apparatus by e.g. resin, glue or paste which functions as a water barrier. The resin, glue, paste or any other water shielding material may optionally be applied to the hollow part 19 of the connector 11 after compression of the stack. To help prevent that the resin may contaminate the stack 3, one or more rubber rings 12 may be provided in the insert 15. A tray 13 may help manufacturing one stack 3 and assembling the stacks 3 together in a housing 21 of the apparatus. Within the housing the stacks 3 may be compressed between the top and bottom parts 22, 24. A top part 23 of the housing 21 has a feed-through allowing the rod 17 to make a connection with a power source. This way electrical charge can enter the first electrode via the first current collector 5 and also leave the electrode again, e.g. during regeneration of the electrodes. Water may be provided to an interior of the apparatus via an inlet 26. The water is allowed to flow around and through capacitor stacks 3 and may enter the stacks via the spacers. The flow through capacitor stack 3 has a hole in the middle of the stack. In the hole a circular tube 29 is provided and via the space between the hole and the tube the water may flow to an outlet 30. The interior of the tube 29 may have a nut 35 and threaded bar 33 which may help to compress the electrodes in the stacks 3 and to compress the stacks 3 between the upper and bottom parts 22, 24 of the housing 21.

Compressing may occur during production of the apparatus, or optionally during maintenance. By compressing all the stacks at once it may help assure that the compression force is very similar or even equal for each stack and at the same time substantially equally or homogeneously distributed over the surface of the electrodes.

During manufacturing of the stack 3 a first electrode comprising a first current collector 5 may be provided in the tray 13. A spacer may be located on top of the first electrode; and a second electrode may be put on top of the spacer. Subsequently a spacer may be put on top of the second electrode followed by another first electrode. This may be repeated until, for example, 10 first and second electrode units are provided in the stack 3 held by the tray 13, each first electrode separated from a second electrode with a spacer. Subsequently a connector part 11 may be located on top of the current collector(s) 5 and a metal insert 15 may be screwed from the other side of the stack 3 through the tray 13 and the first current collectors 5 to fix the stack 3 to the tray 13.

The tray 13 and the stack 3 may be connected to the rod 17 of the first power terminal 27 by sliding the insert 15 over the rod 17 to allow a good electrical contact. The hole in the insert 15 may be of such a size that it allows for good electrical contact between the insert 15 and the rod 17 and at the same time allow the insert 15 to slide over the rod 17. The connector 11 may be pressed on the tray 13 with the current collector(s) 5 in between the connector 11 and the tray 13 by screwing of the insert 15 in the connector part 11. To help assure good electrical conductivity between the connector 11 and the first current collector 5 the pressure on the connector part 15 and the current collector may be less than 100 Bar, less than 50 Bar, less than 20 Bar or around 10 Bar.

Multiple stacks 3 can be connected to the rod 17 and the stacks 3 may be connected in a similar way to the second connector 10. A force may be exerted on the stacks 3 with the nut 35 and threaded bar 33 via the upper and bottom parts 22, 24 so as to compress the first and second electrode in a first direction substantially parallel to the length of the threaded bar 33 which is substantially perpendicular to the main surface of the electrode. The force may exert a pressure on the stack of less than 5 Bar, less than 2 Bar, less than 1 Bar or around 0.5 Bar.

The first and second connectors 11, 10 allow for movement of the first and second current collector 5, 9 along the rod 17, 18 in the first direction such that the current collectors are not substantially damaged by the compression force on the stack 3. The movements may be in the order of 0.05 to 10% of the height of the multiple stacks 3 in the first direction. After enough pressure is exerted on the stack a resin may be provided along or through the first and for second connector 11, 10 in the hollow part 19 of the connectors 10, 11. The resin after hardening fixes the position of the connectors 10, 11 and may protect the (metal) insert 15 and rod 17 from corrosion.

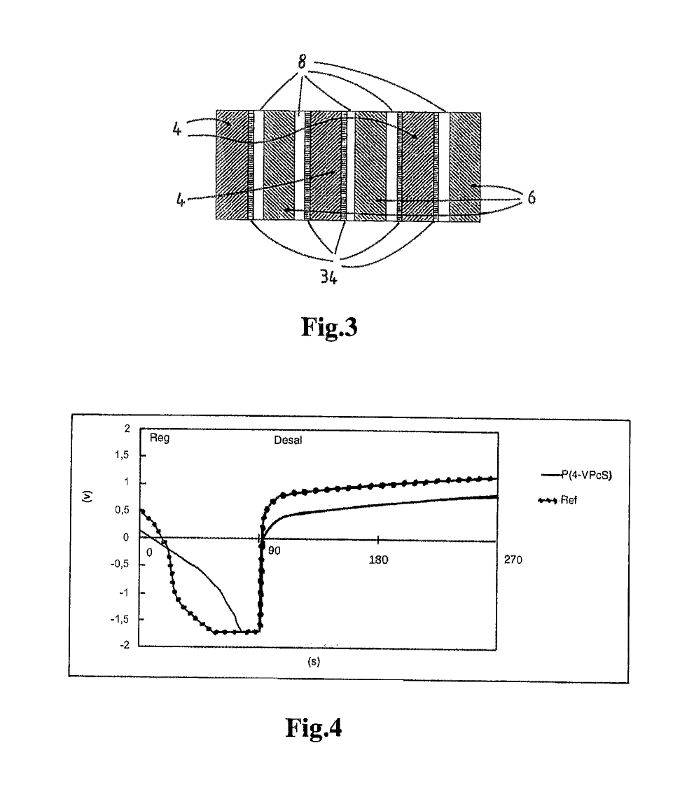

FIG. 3 shows schematically the stacking of electrodes, spacers and membranes in an apparatus to remove ions. The first (4) and second (6) electrodes are stacked with a spacer (8) and an ion exchange membrane. The anion exchange membrane (34) may be positioned between the first electrode (4) and the spacer (8). During on removal a positive voltage may be applied to the first electrode. The anion exchange membrane may allow anions to pass through the membrane towards the first electrode while substantially blocking the cations.

A Method of Preparing an Anion Exchange Membrane with Anion Exchange Groups

In an aspect of the invention, there is provided a method to prepare a crosslinked linear polymer with anion exchange groups, the method comprising:

polymerizing a first monomer with a functional group selected from the pyridine derivatives with a second monomer selected from the benzene derivatives to form a copolymer;

crosslinking the copolymer with a crosslinker; and

functionalizing the functional group to an anion exchange group.

### The Copolymer

The copolymer may be prepared by polymerization of at least two different (co) monomers. The co-monomer may comprise any carbon-carbon unsaturated compound that can be polymerized in an addition polymerization reaction. In an embodiment, when a co-monomer is to be polymerized in an addition polymerization reaction, it can be an ethylenenically monounsaturated monomer, e.g. vinyl or allyl compounds. Many of such molecules are readily available. Examples of co-monomers are vinyl acids, vinyl acid esters, vinyl aryl compounds (including those with heterocyclic aryl groups), vinyl acid anhydrides, vinyl amides, vinyl ethers, vinyl amines, vinyl aryl amines, vinyl nitriles, vinyl ketones, vinyl aldehydes, terminal alkylenes, and derivatives of these monomers as well as corresponding allyl variants thereof. The co-monomer can be hydrophilic or hydrophobic (but hydrophobic polysiloxane chains may be less desired); anionic, cationic, uncharged or zwitterionic; it can be a single molecule, oligomeric or polymeric molecule. In an embodiment, the molecular weight is lower than 950 Dalton. The co-monomer can be uncharged, negatively, or positively charged. A co-monomer may also comprise a mixture of different co-monomers, which may add flexibility, as the polymers may comprise a variety of different co-monomers with different chemistries. A single co-monomer may be desired.

The copolymer may be formed by reacting a first monomer comprising a pyridine derivative as a functional group with at least a second monomer comprising a benzene derivative to form a copolymer. The first monomer with a functional group selected from the pyridine derivatives may include vinyl pyridines such as: 4-vinylpyridine (CAS: 100-43-6), 3-vinylpyridine (CAS 1121-55-7), 2-vinylpyridine (CAS: 100-69-6), 2-methyl-5-vinylpyridine (CAS: 140-76-1) and/or 5-ethyl-2-vinylpyridine (CAS: 5408-74-2).

Alternatively for the first monomer a functional (quaternizable) monomer possessing a ring structure (aliphatic and aromatic) may be used such as: N-vinyl pyrrolidone; N-vinylformamide; 4-vinylaniline; N-vinylcarbazole; 1-vinylimidazole; 1-vinyl-1,2,4-triazole; 2-vinyl-4,5-dihydro-1,3-oxazole; 4,4-dimethyl-2-vinyl-4,5-dihydro-1,3-oxazole; and/or 2-N-morpholinoethyl methacrylate. Further, aliphatic non-ring (linear') functional (quaternizable) monomers (meth)acrylates with tertiary or secondary amine groups may be used such as: 2-(dimethylaminoethyl) (meth)acrylate; 2-(diethylamino)ethyl (meth)acrylate; 2-(diisopropylamino) (ethyl)methacrylate; tert-butylaminoethyl (meth)acrylate; 3-(diethylamino)propyl (meth)acrylate; 3-(dimethylamino)propyl (meth)acrylate; and/or (meth)acrylates with quarternary ammonium groups such as: 2-(meth)acryloyloxy)ethyl-trimethylammonium chloride.

The second monomer comprising a benzene derivative may comprise a polar styrene derivative such as: 4-tert-butoxystyrene (CAS: 95418-58-9), 2,4-dimethylstyrene (CAS: 2234-20-0), 2,5-dimethylstyrene (CAS: 2039-89-6), 3-methylstyrene (CAS: 100-80-1), 4-methylstyrene (CAS: 622-97-9), and/or 2,4,6-trimethylstyrene (CAS: 769-25-5).

A more polar styrene derivative, which is more hydrophilic, may be used such as: 3,4-dimethoxystyrene (CAS: 6380-23-0), 4-methoxystyrene (CAS: 6380-23-0), 3-hydroxystyrene (CAS: 620-18-8), 4-hydroxystyrene (CAS: 2628-17-3), and/or 4-acetoxystyrene (CAS: 2628-16-2).

Linear or branched C₁-C₂₀ acrylates and methacrylates may be used for the second monomer such as: methyl (meth)acrylate; stearyl (meth)acrylate; or 2-ethyl hexyl (meth)acrylate. Methacrylates with alcohol and/or ether groups may be used as the second monomer such as: 2-hydroxyethyl (meth)acrylate; 3-hydroxypropyl (meth)acrylate; glycidyl (meth)acrylates; (meth)acrylic acid esters of (monomethoxy)glycols; tri(alkyloxy)silylalkylene(meth)acrylates such as: trimethoxysilylpropyl(meth)acrylate, and/or vinyl ethers and derivatives such as: methyl vinyl ether and/or vinyl acetate.

It is possible to apply more than one co-monomer, as this provides the opportunity to incorporate ion-exchange groups and/or reactive groups into the copolymer, while it also provides versatility to tailor the properties of the copolymer. Indeed, co-monomers may be desirable that provide the polymers with cations, i.e. anion exchange groups, with anions (i.e. cation exchange groups), with reactive groups and/or with hydrophilic or hydrophobic groups. Hydrophilic co-monomers may for example have alcohol groups, e.g. a co-monomer may be 2-hydroxyethyl (metha)crylate. Hydrophobic co-monomers are for example styrene or 2-ethylhexyl (meth)acrylate.

In another embodiment, a co-monomer may comprise reactive groups that are precursors to ion exchange groups, such as for example amine groups, particularly tertiary amine groups or pyridine groups, as upon quaternization with e.g. a halide or tosylate these reactive groups render quaternary ammonium or pyridinium anion exchange groups, respectively.

### The Crosslinker and the Linear Copolymer

For the preparation of the crosslinked linear polymer with ion exchange groups at least a copolymer and a crosslinker may be provided. The crosslinker may comprise (on average) two reactive groups, although three or more reactive groups are possible. The copolymer has reactive groups that enable reaction, forming a covalent bond, with the crosslinker.

Control over properties and performance of the crosslinked copolymer with ion exchange groups may be exerted by choosing the proper ratio between the copolymer and crosslinker, as this may determine the molar equivalence between the reactive groups on the copolymer and crosslinker. Levels of crosslinking can thus be controlled, as well as the concentration of the ion exchange groups in the crosslinked copolymer with ion exchange groups. The crosslinking reaction may be performed with the aid of a solvent (e.g. an alcohol or non-protic solvent), a reagent (e.g. a non-nucleophilic base such as diisopropylethyl amine), an activating agent (e.g. a carbodiimide agent in reactions between acid and amine reactive groups) and/or a catalyst (e.g. a metal catalyst in reactions between alcohol and isocyanate). The reaction conditions may also be varied with regard to temperature, performing the reaction under an inert gas such as argon or nitrogen, and/or using a light source as reaction initiator or stimulus.

The reactive groups of the crosslinker may react with reactive groups present in the copolymer. Thus, when one of the reactive groups of a crosslinker molecule reacts with a reactive group on a copolymer, the crosslinker molecule is covalently bound with the copolymer molecule. When the other reactive group of the crosslinker reacts with another copolymer molecule, forming a covalent bond with the other copolymer, the crosslinker has formed a crosslink between two copolymer molecules. Hence, when between copolymers crosslinks are formed, a crosslinked copolymer may be formed. Multiple crosslinks between copolymers may occur, and a network of crosslinked copolymers may be formed. The reactive groups of the crosslinker and copolymer may be complementary, such that crosslinkers may not react with each other, and/or copolymers may not react with each other, such that a crosslinker desirably reacts with a copolymer. As copolymers may have a large number of reactive groups, multiple crosslinks between copolymers may be formed, so that the crosslinker has enabled the formation of a covalently connected network of copolymers.

It is possible that to some extent one of the reactive groups of a crosslinker molecule may react with a reactive group on a copolymer, while the other reactive group of the same crosslinker molecule may react with a second reactive group of the same copolymer, thus forming a covalent connection within one copolymer that does not contribute to network formation between copolymer molecules. Such intramolecular reactions, i.e. reactions within a single copolymer molecule, may be controlled by the varying the concentration of reactants. Performing the crosslinking process at high concentration of copolymers may favor the crosslinking process between copolymer molecules, as the chance of an intermolecular reaction between copolymers molecules and a crosslinker molecule increases. Performing the reaction at dilute concentration using a high amount of solvent increases the occurrence of the intramolecular reactions, as the chance of intermolecular reactions between copolymers, of which one already has reacted with a crosslinking molecule is reduced, and an intramolecular crosslink may be favored. It is therefore desirable to do the crosslinking step at a high concentration of the copolymer, using little solvent, as this may be favorable for efficient crosslinking.

Linear copolymers may be less soluble, thus reactions are carried out in less favorable conditions. However polymerizing a first monomer with a functional group selected from the pyridine derivatives with a second monomer selected from the benzene derivatives to form a copolymer may provide a well soluble copolymer and with regard to intermolecular crosslinking, when such copolymers are crosslinked, intramolecular crosslinks may more often be formed.

Properties of the linear copolymer, such as high solubility, low solution and melt viscosities and/or high number of reactive groups per molecule, thus may allow for an easy and efficient crosslinking step that can result in dense concentrations of ion exchange groups in the crosslinked membrane with ion exchange groups. Not much solvent may be needed to dissolve large quantities of copolymer, so the solution can still have low viscosity which may make it easier to handle. The crosslinking step may run smoothly and to high conversions, first in solution when there may be a high concentration in reactive groups, and after the solvent has evaporated in the bulk, viscosities can remain relatively low enhancing the diffusion of reactants.

The crosslinker or the linear copolymer may comprise an ion exchange group, such that when the linear copolymer and crosslinker are reacted a crosslinked polymer with ion exchange groups is formed.

As long as a crosslinker and a linear copolymer may have complementary reactive groups, i.e. they can react with each other forming crosslinks, such a crosslinker and linear copolymer may be used. Thus, the complementary reactive groups in the crosslinker and the linear copolymer may be any combination of two reactive groups that effectively leads to a covalent bond formation between the crosslinker and linear copolymer. For example, one may comprise tertiary amine, pyridine or tertiary phosphine reactive groups, while the other may have halide, tosylate, mesylate or triflate reactive groups, such that upon crosslinking, quaternary ammonium, pyridinium or quaternary phosphonium crosslinks may be formed.

Accordingly, examples of crosslinkers are diamines, dihalides, ditosylates, dimesylates, diols, dicarboxylic acids, di-activated esters, di-vinyl compounds, dianhydrides, particularly di cyclic anhydrides, di-isocyanates and di-epoxides. Crosslinkers that may be used include di-cyclic anhydrides, diamines, dipyridines and dihalides. For amine groups in the crosslinker, either primary or secondary amines can be used, which are reactive towards e.g. carboxylic acids and its derivatives or towards sulfonates and its derivatives. Tertiary amines can also be used and are desirable as these can generate ion exchange groups upon reaction with e.g. halides. In case halides are used, the more reactive halides are desirable, such as activated halides (e.g. benzyl chlorides), bromides and iodides. Crosslinker molecules may include, for example, di-cyclic anhydrides such as pyromellitic dianhydride, EDTA-dianhydride, DTPA-dianhydride, benzophenone-3,3′,4,4′-tetracarboxylic dianhydride, di primary amines such as diaminobutane and diaminohexane, di secondary amines such as piperazine and N,N′-dimethyl alkanediamines, di tertiary amines such as tetramethyl alkanediamines, dipyridines such as 4,4′-bipyridine, or dihalides such as 1,6-diiodohexane, 1,6-dibromohexane, 1,10-dibromodecane.

In an embodiment of the method for preparing the crosslinked copolymer with ion exchange groups, an ion exchange group is formed during the crosslinking step. In an embodiment, the copolymer and crosslinker comprise reactive groups that are capable of reacting with each other forming a covalent bond and an ion exchange group. The ion exchange group that is formed may be an anion exchange group.

When the ion exchange group is an anion exchange group, the reactive group of the copolymer is desirably a pyridine and the reactive group of the crosslinker may be a halide, tosylate, mesylate or triflate group. Thus, pyridinium anion exchange groups may be created when the copolymer and the crosslinker have reacted.

The reaction of the linear copolymer with the crosslinker may result in the formation of an ion exchange group, while simultaneously crosslinking the linear copolymers, thus preparing a crosslinked copolymer with anion exchange groups. In addition, or alternatively, the linear copolymer and/or the crosslinker may already comprise ion exchange groups. With comprising ion exchange groups it is meant that the ion exchange groups are covalently bound to the copolymer, crosslinker and/or crosslinked copolymer. Alternatively, ion exchange groups may also be covalenty bound to a crosslinked copolymer already prepared, forming a crosslinked copolymer with ion exchange groups, although this may be less desired as it involves an extra step. In any of those cases, a crosslinked linear copolymer with ion exchange groups is prepared.

In a further embodiment, the crosslinker and/or copolymer may comprise hydrophilic groups and/or hydrophobic groups. Providing such groups may affect the reaction conditions (e.g. solvents, reaction kinetics) during the crosslinking step and/or the properties of the crosslinked copolymer with ion exchange groups membrane material.

Ion Exchange Group Formation or Activation without Crosslinking the Copolymer

Formation of ion exchange groups may also be performed without crosslinking the copolymer. This way the level of crosslinking between and within the polymers may be reduced. The ion exchange capacity of the membrane may not be reduced. The ion exchange capacity may also be increased without increasing crosslinking. An advantage of a lower level of crosslinking may be that the membrane becomes less electrically resistant to ion transport. This in turn may improve the desalination performance of the FTC system.

The formation or activation of ion exchange groups can be performed by using a group activator. A group activator is a compound that can react with the copolymer, e.g. with a nitrogen atom or group at the copolymer, which leads to a charged group in the copolymer. In an embodiment, the group activator comprises one reactive group, which is capable of reacting with the copolymer. The copolymer may have multiple groups that may react with the group activator and form a covalent bond. The average number of these reactive groups per copolymer molecule is at least 1, at least 4, at least 6 or at least 10. An average number of reactive groups per copolymer may also further describe the copolymer as a copolymer usually has a heterogeneous mixture of macromolecules. In an embodiment, the reactive groups of the copolymer that may react with a group activator are the same reactive groups that may react with a crosslinker. The reactive group of the group activator may be the same reactive group of the crosslinker that can react with the copolymer. The reactive group of the group activator may be different from the reactive group of the crosslinker, as long as both can react with the reactive groups of the copolymer. Different reactive groups for both the crosslinker and group activator may be contemplated.

Control over properties and performance of the crosslinked polymer with ion exchange groups may be exerted by choosing the proper ratio between the copolymer, group activator and crosslinker, as this may determine the molar equivalence between the reactive groups on the polymer, group activator and crosslinker. The molar ratio between the group activator and the crosslinker may be any number from 3:1 or even higher or be as low as 1:3 or even lower.

The group activator may be reacted with the copolymer before, during or after the crosslinking step.

In one embodiment, the crosslinking step is performed with a limited amount of crosslinker such that not all the reactive groups of the copolymer available for crosslinking have reacted. In a post-crosslinking step, the reactive groups of the crosslinked polymer may be subjected to a reaction with a group activator such that remaining reactive groups of the copolymer react with the group activator.

In one embodiment, the crosslinking step is performed in the presence of both a crosslinker and a group activator. The ratio between the crosslinker and the group activator may control the extent of crosslinking. Having a relatively low amount of crosslinker may result in a lower extent of crosslinking. It is understood that not only the ratio of crosslinker and group activator may determine the extent of crosslinking. For example, the reactivity of the crosslinker and group activator may also or alternatively determine the extent of crosslinking. The molar ratio between the group activator and crosslinker may range from 1:100 to 100:1. The molar ratio between the group activator and the crosslinker may range from 20:1 to 1:20. The molar ratio between the group activator and the crosslinker may be 3:1 or higher. The molar ratio between the group activator and the crosslinker may be 1:3 or lower. It is understood that as long as the amount of crosslinker in the reaction mixture comprising the crosslinker and the group activator is sufficient to substantially crosslink the copolymer, such a ratio may be selected in this embodiment.

In one embodiment, prior to the crosslinking step the copolymer is reacted with a group activator. The amount of group activator is such that at least 2 reactive groups or at least 3 reactive groups remain on average per copolymer for the subsequent crosslinking step.

Reaction conditions for reacting a group activator (prior, during or after crosslinking) with a copolymer may be selected that are highly similar to the reaction conditions for performing a crosslinking step.

The degree of crosslinking can thus be controlled, as well as the level of ion exchange groups in the crosslinked copolymer. The group activation reaction may be performed with the aid of a solvent (e.g. an alcohol or non-protic solvent), a reagent (e.g. a non-nucleophilic base such as diisopropylethyl amine), an activating agent (e.g. a carbodiimide agent in reactions between acid and amine reactive groups) and/or a catalyst (e.g. a metal catalyst in reactions between alcohol and isocyanate). The reaction conditions may also be varied with regard to temperature, performing the reaction under an inert gas such as argon or nitrogen, and/or using a light source as reaction initiator or stimulus.

The reactive group of the group activator may react with reactive groups present in the copolymer. Thus, when one of the reactive groups of a group activator molecule reacts with a reactive group on a copolymer molecule, the group activator molecule may be covalently bound with the copolymer molecule. Hence, the ion exchange group is formed without crosslinking of the copolymer. The reactive groups of the group activator and copolymer may be complementary, such that group activators may not react with each other and may not react with the crosslinker, while copolymers may not react with each other, such that a group activator desirably reacts exclusively with a copolymer.

The group activator or the copolymer may comprise an ion exchange group, such that when the copolymer and the group activator are reacted a copolymer with ion exchange groups is formed. In a particular embodiment, a copolymer may have reactive groups that are ion exchange groups such as e.g. carboxylate or sulfonate groups, which groups may be converted to amide or sulfonamide linkages by reaction with amine groups in a group activator.

As long as a group activator and a copolymer may have complementary reactive groups, i.e. they can react with each other forming an active ion exchange group, such a group activator and copolymer may be used. Thus, the complementary reactive groups in the group activator and the copolymer may be any combination of two reactive groups that effectively leads to a covalent bond formation between the group activator and copolymer. For example, one may have alcohol reactive groups, while the other may have carboxylic acid, carboxylic (activated) ester or anhydride reactive groups to enable the formation of ester linkages; the other may have isocyanate reactive groups thus forming urethane linkages; the other may have halide, tosylate, mesylate or triflate reactive groups thus forming ether linkages. Furthermore, one of the reaction components (polymer or group activator) may comprise primary amine or secondary amine reactive groups, while the other reaction component may have isocyanate reactive groups (to form urea linkages), carboxylic acid, carboxylic (activated) ester or (cyclic) anhydride reactive groups (to form amide linkages), ethylenenically monounsaturated reactive groups such as (meth)acrylates, (meth)acryl amides or vinyl derived groups (to form amine linkages in Michael-type of additions), epoxide reactive groups (to form an amine alcohol linkage), sulfonate or activated sulfonate reactive groups (to form sulfon amide linkages), or halide, tosylate, mesylate or triflate reactive groups (to form secondary or tertiary amine linkages). Alternatively, one may comprise tertiary amine, pyridine or tertiary phosphine reactive groups, while the other may have halide, tosylate, mesylate or triflate reactive groups, such that upon group activation, quaternary ammonium, pyridinium or quaternary phosphonium linkages may be formed.

Accordingly, examples of group activators are monoamines, monohalides, monotosylates, monomesylates, alcohols, carboxylic acids, activated esters, monovinyl compounds, monoisocyanates and epoxides. Group activators that may be used are monoamines, monopyridines and monohalides. For amine groups in the group activator, either primary or secondary amines can be used, which are reactive towards e.g. carboxylic acids and its derivatives or towards sulfonates and its derivatives. Tertiary amines can also be used and are desirable as these can generate ion exchange groups upon reaction with e.g. monohalides. In case halides are used, the more reactive halides are desirable, such as activated halides, bromides and iodides. Group activator molecules are for example primary amines, secondary amines such as methyl alkaneamines, tertiary amines such as tetramethyl alkaneamines, pyridines, monohalides such as alkyl or benzyl halides such as methyl halides, and/or ethyl halides.

In another embodiment of the method for preparing the copolymer with ion exchange groups, an ion exchange group is formed during the group activation step. In an embodiment, the copolymer and group activator comprise reactive groups that are capable of reacting with each other to form a covalent bond and an ion exchange group. The ion exchange group that is formed may be a cation exchange group or an anion exchange group.

When the ion exchange group is an anion exchange group, the reactive group of the polymer is desirably a tertiary amine, a pyridine, a guanidine and/or a phosphine group and the reactive group of the group activator may be a halide, tosylate, mesylate or triflate group, or the reactive group of the group activator is desirably a tertiary amine, a pyridine, a guanidine and/or a phosphine group and the reactive group of the copolymer may be a halide, tosylate, mesylate or triflate group. Thus quaternary ammonium, pyridinium, guanidinium or phosphonium anion exchange groups are created, respectively, when the copolymer and the group activator have reacted.

The reaction of the copolymer with the group activator may result in the formation of an ion exchange group. In addition, or alternatively, the copolymer and/or the group activator may already comprise at least one ion exchange group. With comprising ion exchange groups it is meant that the ion exchange groups are covalently bound to the copolymer, group activator, crosslinker and/or crosslinked polymer. Alternatively, ion exchange groups may also be covalenty bound to a crosslinked polymer already prepared, forming a crosslinked polymer with ion exchange groups. As long as a crosslinked polymer with ion exchange groups is prepared or provided, such a crosslinked polymer with ion exchange groups may be used.

In a further embodiment, the group activator and/or polymer may comprise hydrophilic groups and/or hydrophobic groups. Providing such groups may affect the reaction conditions (e.g. solvents, reaction kinetics) during the crosslinking step and/or the properties of the crosslinked copolymer with ion exchange groups.

### The Ion Exchange Groups

The ion exchange groups may be dissociable depending on the pH, but are desirably not pH-dependent, i.e. they do not change their charge upon pH-changes. Alternatively, the ion exchange groups may not be pH-dependent over a broad pH-range, for example from pH 5 to 9, from 3 to 11, from 2 to 12, from 1 to 13 or even beyond. Ion exchange groups may either be anion exchange groups or cation exchange groups.

Anion exchange groups are positively charged and may be based on nitrogen or phosphor atoms that desirably do not bear any hydrogen atoms. Examples of anion exchange groups are quaternary ammonium charges (NR₄), quaternary phosphonium charges (PRA guanidinium charges, pyridinium charges or charges formed from nitrogen containing heterocycles other than pyridine, such as for example imidazoles, triazoles or oxazoles. Most desired may be pyridinium charges. The so-called strongly basic on exchange groups (e.g. quaternary ammonium groups) are desired over weakly basic groups (e.g. secondary or tertiary amines).

### The Preparation of the Copolymer

The copolymer may be prepared by various methods known in the art and are usually prepared by step-growth methods or by chain-growth methods. In a typical step-growth method an ABₓ branching monomer is polycondensed (dependent on the availability of suitable monomers; usually x=2, where x represents the number of functional groups B in the monomer), where the functional groups A react with B, and not with other A groups. The B groups also do not react with each other, and have an equal or similar reactivity towards A. Side reactions are prevented or are insignificant. The result is a polymer with a high functionality in B-groups. A number of variations and modifications of a step-growth method are possible, and have been developed. For example, in addition to the AB_{X} monomer, a multifunctional B_{y} monomer (where y represents the number of functional groups B in the monomer), an AB monomer, or a monomer with only one A-group may be used. In other frequently used methods, the multifunctional monomers A₂ and B_{y} are combined to produce a polymer material. Here, in principle, crosslinking may occur, but by controlling the conversion of the polymerization, undesired gelation may be prevented. Another way to circumvent crosslinking in the reaction between A₂ and B_{y} monomers is that one of the B-groups has a much higher reactivity towards the A-group (and therefore is in fact a C-group), so that an AB_{X} monomer is formed in-situ. Step-growth methods have also been described by the way in which the monomer is used or applied (see Gao and Yan, Prog. Polym. Sci., 29, 2004), discriminating between single monomer methodologies (SMM), double monomer methodologies (DMM) and couple-monomer methodologies (CMM), where in the latter case the AB_{X} branching monomer is formed in situ.

Step-growth methods are usually polycondensation reactions, leading to polyesters, polyamides, polycarbonates, polyureas, polyurethanes, polyethers or polyarylenes, but Michael-type of additions, i.e. additions where a primary or secondary amine adds to a double bond (leading to polyamine), or additions of alcohol to isocyanate (leading to polyurethane) are also possible.

Chain growth methods that may also be used to prepare polymers are radical addition polymerization reactions, ring opening reactions, or anionic or cationic (living) polymerizations. The radical addition polymerizations may be free radical polymerizations, or controlled radical polymerizations that are known in the art, such as nitroxide-mediated radical polymerization (NMRP), atom-transfer radical polymerization (ATRP) or reversible addition-fragmentation chain transfer polymerizations (RAFT). Other controlled chain-growth processes that may be used are group-transfer polymerizations, ruthenium-catalyzed co-ordinative polymerizations or ring opening metathesis polymerizations (ROMP).

A chain-growth method to prepare polymers may be according to the so-called self-condensing vinyl polymerization (SCVP), wherein an AB* branching monomer, in which A is a vinylic group that is capable of chain-growth vinyl-polymerization and B* is a group that potentially generates initiating sites for this vinyl-polymerization, providing the third direction in which the polymer chain may grow. The AB* branching monomer may be combined with an A monomer, so that not every monomeric unit is a potential branching unit. Similarly, in the self-condensing ring-opening polymerization (SCROP), that is also called ring-opening multibranching polymerization (ROMBP), an AB* monomer is used, where A is a heterocyclic ring capable of ring-opening polymerization, and B* is an initiating group for this ring opening polymerization. The AB* monomer may be combined with a cyclic A monomer, so that not every monomeric unit is a potential branching unit. Glycidol is an example of an AB* monomer that is suitable for use in SCROP (or ROMBP).

According to the above, chain growth methods may involve the use of either vinylic monomers (leading to poly-vinyl type of polymers) and/or cyclic monomers (typically leading to polyethers or polyesters). Vinylic monomers can be (meth)acrylates, (meth)acryl amides, vinyl ethers, vinyl esters or vinyl aryl monomers. Combinations of these types of vinyl monomers may be suitable as well. Examples of cyclic monomers are epoxides, oxetanes, caprolactones or urethanes.

### Preparing a Copolymer by an Addition Polymerization Reaction

The methods for preparation of copolymers described above are methods describing general ways to prepare copolymer, and are not limited thereto. It may be of interest to provide for a versatile method in which the copolymer is synthesized in one synthetic step, after which the copolymer can be used for the preparation of the crosslinked polymer with ion exchange groups, without having to do resort to a post-modification reaction step(s) on the polymer.

In one aspect, a copolymer is prepared by a method, comprising the steps of:

providing a first monomer with a functional group selected from the pyridine derivatives,

providing a second monomer selected from the benzene derivatives, optionally providing one or more branching monomers,

providing an initiator, desirably a free radical initiator,

optionally providing a chain transfer agent, and

reacting the co-monomers, the optional branching monomer(s), the initiator and the optional chain transfer reactant to form a copolymer.

In one embodiment, the reaction step may involve an addition polymerization reaction or, desirably, a free-radical polymerization reaction. In this method, the chemistry of the reactants (i.e. co-monomers, initiator, (optional) branching monomer and/or (optional) chain transfer agent) and the reaction conditions may be selected such that crosslinking reactions may be prevented between copolymer molecules that are being formed during the reacting step (i.e. preventing gelation or solidification).

In an embodiment, the branching monomer comprises at least two vinyl groups, and the co-monomer comprises one vinyl, where the vinyl groups are suitable for addition polymerization. In an embodiment, the product is a poly(4 vinyl pyridine-co-styrene).

The preparation methods and reactants (e.g. branching monomer, co-monomer, initiator and/or chain transfer agent) described below are versatile in the sense that the copolymer may be prepared from readily available monomers and reactants, and that it can be tailored with respect to its properties by simply varying the used amounts of the (optional) branching monomer, the co-monomer(s), the initiator and the (optional) chain transfer agent. The extent of branching of the copolymer may be controlled by adjusting the amount of branching monomer in the polymerization reaction, while the use of the types and amounts of co-monomers may determine the type and amount of ion exchange groups and/or reactive groups in the polymer. Care may be taken to select a ratio between the chain transfer agent and the branching monomer such that gelation is prevented during the polymerization reaction, while still generating a copolymer of a substantial molecular weight, e.g. with copolymer molecules with a number average molecular weight (Mn) in the range of 250 Dalton to 100,000 Dalton (see for example O'Brien, Polymer, 41, 2000, 6027-6031). All branched monomers, co-monomers, initiators and/or chain transfer agents may comprise groups, or may transfer groups, such that the copolymer formed may comprise these groups.

When co-monomers are combined, for instance to provide for different chemistries in the copolymer, e.g. see example Reaction scheme 1 wherein 4-VP provides for a pyridine and HEMA/MMA provides for hydrophilic groups, one co-monomer may have a high reactivity with the CTA. Because of this high reactivity, a side product may be formed when the CTA and this co-monomer react. When this is the case, more of the CTA and more of the co-monomer may be used to compensate for the loss of reactants in the side product. For example, the co-monomer 4-vinyl pyridine can readily form a thioether side product with a linear primary thiol CTA. For instance, the amounts of CTA and/or co-monomer may be increased in the reaction mixture, whereas the amount of CTA and/or co-monomer incorporated is similar (see Table 1 and Table 2, compare e.g. 12A with 21).

In the reaction mixture, the amount of co-monomer(s) used is desirably in the range of 40 mol/mol % to 98 mol/mol %, and the amount of branching monomer(s) and/or CTA is desirably from 2 mol/mol % to 50 mol/mol %. The initiator can be used in amounts varying from 0.01 mmol/mol°/0 to about 5 mol/mol %, relative to the amount of co-monomer(s), branching monomer(s) and CTA reactants. When higher molar percentages of initiator are used, the application of inhibitor additives or retarding agents (e.g. benzoyliminoacetate) may be considered. However, inhibitors or retardants may be avoided when about 1 mmol/mol % of initiator is used.

The radical polymerization reaction may be performed using reaction conditions known to the skilled person, selecting a solvent (e.g. toluene or ethanol), concentration of reactants and monomers (i.e. solids), temperature and addition method of monomers, reactants and/or solvent as are known in the art for polymerization reactions. Desirably, the reaction is performed in alcohols such as ethanol, with concentrations ranging between 3 w/w % and 30 w/w % in solids or between 10 w/w % and 25 w/w %, at temperatures between 60° C.-90° C. In an embodiment, all monomers, reactants and solvents are premixed before the start of the reaction. Prior to a radical polymerization, the reaction mixture is desirably freed of oxygen, for example by purging it with an inert gas such as nitrogen.

The copolymer may next be isolated. The copolymer may for instance be isolated by precipitation or stirring in a non-solvent for the copolymer. For this purpose the solvent in which the reaction was carried out may first be evaporated, prior to addition of the non-solvent. In the precipitation step by-products or less-preferred product fractions of low molecular weight may be removed.

Alternatively, the reaction mixture comprising the copolymer may also be directly used for the crosslinking reaction, forming a crosslinked copolymer with ion exchange groups.

### The Optional Branching Monomer

A branching monomer may be a molecule comprising two vinyl groups (i.e. an ethylenenically diunsaturated monomer). The branching monomer may also comprise more than two vinyl groups. These vinyl groups can be polymerized in an addition polymerization reaction and may be provided in relatively low amount compared to the first monomer with a functional group selected from the pyridine derivatives and the second monomer selected from the benzene derivatives to provide some amount of branching in the polymer. Many of such molecules are readily available, or may be prepared by reacting any di- or multifunctional molecule with a suitably reactive vinylic reactant. Examples include di- or multivinyl esters, di- or multivinyl amides, di- or multivinyl aryl compounds (including those with heterocyclic aryl groups), and di- or multivinyl alkyl/aryl ethers. The branching monomer may be hydrophilic or hydrophobic (but hydrophobic polysiloxane chains may be less desired). The branching monomer can be either uncharged or negatively or positively charged. The branching monomer may be a single molecule, an oligomeric molecule or a polymeric molecule. The branching monomer may also comprise a mixture of different branching monomers. The molecular weight of a branching monomer may be lower than 950 Dalton. The branching monomer may desirably be uncharged, and desirably a single compound.

Branching monomers include, but are not limited to, divinyl aryl monomers such as divinyl benzene (DVB); (meth)acrylate diesters such as alkylene di(meth)acrylates such as ethylene glycol di(meth)acrylate, propylene glycol di(meth)acrylate, 1,4-butylene glycol di(meth)acrylate; oligo alkylene glycol di(meth)acrylates such as tetraethyleneglycol di(meth)acrylate, poly(ethyleneglycol) di(meth)acrylate, poly (propyleneglycol) di(meth)acrylate; divinyl (meth)acrylamides such as methylene bisacrylamide; divinyl ethers such as poly(ethyleneglycol)divinyl ether; and tetra- or tri-(meth)acrylate esters such as pentaerythritol tetra (meth)acrylate, trimethylolpropane tri(meth)acrylate or glucose di- to penta (meth)acrylate. Desirable branching monomers may be divinyl benzene, α,ω-alkylene di(meth)acrylates, divinyl (meth)acrylamides, ethylene glycol di(meth)acrylate, 1,4-butylene glycol di(meth)acrylate and/or methylene bisacrylamide.

In an embodiment, the branching monomer is a di(meth)acrylate, a bisacrylamide, 1,4-butanediol dimethacrylate or methylene bisacrylamide.

### The Initiator and the Chain Transfer Agent

The initiator is a molecule that can initiate a polymerization reaction. In case the polymerization reaction is a (free)-radical polymerization reaction, the initiator may be a (free)-radical initiator which may be any molecule known to initiate such a reaction, such as e.g. azo-containing molecules, peroxides, persulfates, redox initiators, and benzyl ketones. Such initiators may be activated via thermal, photolytic or chemical means. Examples of (free)-radical initiators are 2,2′-azobisisobutyronitrile (AIBN), azobis(4-cyanovaleric acid), benzoyl peroxide, cumylperoxide, 1-hydroxycyclohexyl phenyl ketone and hydrogenperoxide/ascorbic acid. The so-called iniferters may also be considered as initiators. AIBN may be desirable as a (free)-radical initiator.

The chain transfer agent or reactant is a molecule that can control, limit and reduce the molecular weight during radical or free-radical polymerization via a chain transfer mechanism, as is known in the art. For example, a chain transfer agent in a radical polymerization reaction can react with the group of the polymer comprising the radical, such that the radical is transferred to the chain transfer agent. The result is that the chain transfer agent comprises the radical, and the polymerization of the group of the polymer that previously comprised the radical has stopped. The use of a chain transfer agent may prevent that the polymerization reaction will result in crosslinking reactions and gel formation. The chain transfer agent in a radical polymerization reaction may be any thiol-containing molecule and can be mono- or multifunctional. Examples of suitable thiols are linear or branched C2-C18 alkyl thiols such as dodecane 1-thiol, thioglycolic acid, thioglycerol, cysteine and cysteamine, 2-mercaptoethanol, thioglycerol, dithiothreitol (DTT) and ethylene glycol mono- (and di-)thio glycollate. Thiols may in addition bear reactive and/or ion exchange groups, such as carboxylic acids, amines or alcohols. Apart from thiols, other agents that can stabilize a radical and/or that are known to limit the molecular weight in a free-radical addition polymerization may be considered. For example, hindered alcohols, organic complexes of cobalt are known as chain transfer catalysts, such as bis(borondifluorodimethyl-glyoximate) (CoBF) or cobalt oximes, and reversible addition fragmentation transfer (RAFT) agents such as xanthates, dithioesters and dithiocarbonates, or alkyl halides. A desirable chain transfer agent is a thiol, an organic thiol, or an organic linear or branched C6-C20 alkyl thiol.

### An Ion Exchange Membrane Comprising the Crosslinked Copolymer Ion Exchange Groups

A crosslinked copolymer with ion exchange groups obtainable or obtained by the methods as described herein may be provided. Such a crosslinked copolymer with ion exchange groups may be in the form of a sheet. An embodiment of the invention provides for an ion exchange membrane comprising the crosslinked copolymer containing ion exchange groups, that desirably is prepared as a sheet.

The crosslinked polymer may have gel like or solid like properties. The crosslinking reaction may be performed in a coating or a film, such that a sheet of crosslinked copolymer is formed. The reactive film may be prepared by any processing technique feasible, such as for example by spraying a solution that contains both the copolymer and the crosslinker onto a surface, or by applying such a solution onto a substrate by any coating technique, e.g. by a so-called doctor blade, roll to roll, knife over edge or slot dye coating technique.

The crosslinking reaction may be performed directly onto the surface or substrate of choice, for example onto a specific support layer or onto an electrode. By crosslinking the copolymer on the electrode the strength of the membrane and the electrode may be increased. The increased strength may be used to make the electrode and or the membrane thinner. Furthermore, stack assembly may become easier because fewer layers may need to be stacked during assembly because two layers are already integrated with each other. The crosslinking reaction on the electrode may help assure that there is intimate contact between the electrode and the membrane. This way air and/or water pockets between the electrode and the membrane may be avoided. The crosslinker and copolymer may be provided directly onto the electrode, whereby the membrane network is formed in situ. The crosslinker and copolymer may be partially penetrating into the electrode to enhance intimate contact between membrane and electrode. This may be done by impregnating the electrode with a solvent, e.g. water and casting the membrane casting solution onto the electrode, whereby the casting solution is capable of wetting the electrode surface (containing the electrode solvent, e.g. water). During cross linking the membrane onto the electrode, the membrane could even be partially crosslinked with the electrode, which would lead to a stronger bond between electrode and membrane than when the bond is only by a physical attraction force. A strong bond between membrane and electrode may help in reducing a potential swelling of the membrane along the electrode surface, once the membrane is brought in contact with water. In addition, the strong bond may also help in preventing that the membrane becomes loose and/or delaminated from the electrode surface.

In a further embodiment the crosslinking may be done partially with the spacer that is applied against the membrane. By doing the crosslinking onto the spacer, there will be intimate contact between the membrane and the spacer and the spacer and membrane layers will be integrated into one layer, which will make stack assembly easier.

The crosslinking reaction may be performed to prepare small sphere-like shaped crosslinked copolymer particles (e.g. microspheres), for example by performing the crosslinking in small droplets, which may be used to prepare e.g. a paste, such that the crosslinked copolymers may be applied to irregular surfaces or shapes.

The crosslinking step may at first instance be done partially in a reactor, and may subsequently be transferred to the object, substrate or surface of choice, where the reaction may be completed. Since during the crosslinking step the viscosity of the reaction mixture may increase, due to the crosslinks that are formed, the properties of the reaction mixture may change from a liquid to a more viscous, paste like mixture which may make it convenient to apply the reaction mixture to a surface, or a mold, which may even have an irregular surface. Hence, it may be advantageous to transfer the reaction mixture during the reaction to an object, substrate or surface of choice, where the reaction will be completed.

In another aspect, an ion exchange membrane is provided which comprises sheets of crosslinked copolymer with ion exchange groups, wherein the thickness of the sheets of crosslinked copolymer with ion exchange groups is less than 200 micrometers, less than 100 micrometers, less than 60 micrometers or less than 30 micrometers.

The concentration of the ion exchange groups, either cationic or anionic, in the crosslinked copolymer with ion exchange groups is between 0.2 and 6 mmol per gram, between 0.8 and 5 mmol per gram, between 1.4 and 4 mmol per gram, between 2 and 3 mmol per gram or between 2.2 and 2.7 mmol per gram. These numbers refer to a dry crosslinked copolymer with ion exchange groups. In an embodiment, the crosslinked copolymer with ion exchange groups comprises between 25% and 95%, between 40% and 85%, or between 55% and 80% by weight of the copolymer. The concentrations of ion exchange groups in mmol/g of dry crosslinked copolymer with ion exchange groups, and percentages by weight of copolymer in the dry crosslinked copolymer with ion exchange groups may e.g. be calculated from the amounts of copolymer and crosslinker that have been used in the preparation of the crosslinked copolymer membrane material.

Furthermore, the crosslinked copolymer with ion exchange groups material may comprise additional hydrophilic groups, such as for example alcohol or amide groups, and/or additional hydrophobic groups, such as for example C₈ or higher alkyl or alkylene groups, where these hydrophilic and/or hydrophobic groups may originate from the crosslinker and/or from the copolymer. In this way, the crosslinked copolymer with ion exchange groups may be more compatible with water and/or may improve the electrical conductive properties of the crosslinked copolymer with ion exchange groups and/or may improve the performance of the membrane material.

The (sheets of) crosslinked copolymer with ion exchange groups, that may be used for ion exchange membranes, may have little or no curling or delamination when after preparation they are brought in contact with water and also at the same time may show little swelling. Furthermore, advantageous permselectivities may be obtained with crosslinked copolymers with ion exchange groups. As is described in the examples, for instance, permselectivities higher than 90% may be obtained with sheets in the range of 40 micrometers (see example 17). Permselectivity or permeability selectivity, is defined as the percentage of cations or anions, of the total amount of ions that may be taken up by a membrane, in this case a membrane comprising the crosslinked copolymers with ion exchange groups. When a membrane has a permselectivity of 100% for anions, this means that 100% of the ions may be taken up by the membrane are anions. When the permselectivity is reduced e.g. by 5% to a permselectivity of 95%, this means that 95% of the ions that are taken up by the membrane are anions, and 5% are cations. Please note that for ion exchange membranes, especially for those applied in FTCs, every percent increase in permselectivity may be very valuable, with 100% being the maximum selectivity achievable. Also, a low resistance, as low as 5 ohm*cm², or even as low as 1.5 ohm*cm², may be desirable for the prepared sheets of crosslinked copolymers with ion exchange groups.

### EXAMPLES

### Experimental Details

All solvents were of AR quality if not stated otherwise and were purchased from commercial sources (Biosolve or Acros). Petroleum ether (boiling point range 60-80° C.) was purchased from ABCR. Deuterated solvents were purchased from Cambridge Isotope Laboratories and were dried over molsieves. The monomers 2-hydroxyethyl methacrylate (HEMA) (97%), methyl methacrylate (MMA) (99%) and the branching monomer divinylbenzene (DVB) (70-85%) were purchased from Aldrich. DVB consists of a mixture of 1,4-divinylbenzene and 1,3-divinylbenzene and contains significant amounts of ethylvinylbenzene and diethylbenzene. The chain transfer agent 1-dodecane thiol (99%), the monomers 4-vinyl pyridine (4-VP) (95%) and styrene (99.5%), the initiator 2,2′-azo-bis(2-methylpropionitrile) (AIBN) (98%) were purchased from Acros. ¹H-NMR spectra were recorded in CDCl₃ on a Varian 400 MHz or 200 MHz NMR spectrometer, where ¹H-NMR chemical shifts are given in ppm, and were determined using tetramethylsilane (TMS) as internal standard (0 ppm). Infrared spectra of samples were recorded on a Perkin Elmer Spectrum One 1600 ATR FT-IR spectrometer. Wavenumbers are given in cm⁻¹. GPC (or SEC) chromatograms of the polymers were measured using 10 mM of LiBr in DMF as eluent, applying a 1 mL/min eluent flowrate, a sample concentration of 2 mg/mL in 10 mM of LiBr DMF and an injection volume of 20 microL. A Polymer Laboratories PL-GPC50 Plus Integrated GPC system was used, equipped with a Polymer Standards Service (PSS) Gram analytical linear M column (dimensions 8×300 mm, particle-size 10 micro-m, mass range: 500-1000000 Da) that was operated at 50° C. and applying refractive index (RI) detection. Calibration was performed with polyethyleneoxide reference standards. Elemental analysis was performed on a Perkin Elmer 2400 machine, where elemental contents are given in weight percentages. DSC was performed on a TA Q2000 instrument, where monitored samples are kept under a nitrogen atmosphere. Glass transition temperatures (Tg) are given as observed during the second heating run using a heating rate of 20° C./min.

### The Preparation of the Copolymers

Copolymers were synthesized in addition polymerization reactions, Methacrylate/4-vinyl pyridine based copolymers (see Scheme 1) as well as styrene/4-vinyl pyridine based copolymers (see Scheme 2) were prepared. Also a styrene/4-vinyl pyridine hyperbranched copolymer with divinyl benzene as branching monomer was prepared (see Scheme 2).

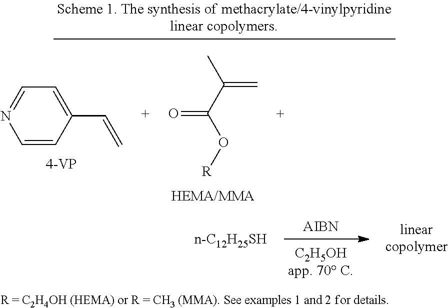

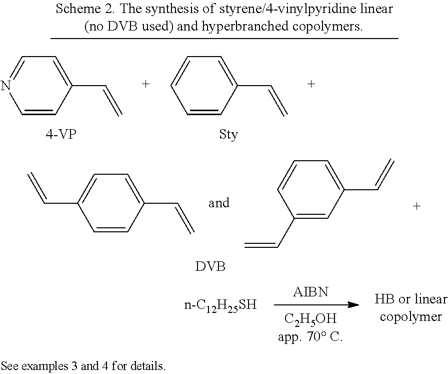

For the methacrylate based linear polymers with pyridine groups (Scheme 1), 2-hydroxyethyl methacrylate (HEMA) or methyl methacrylate (MMA) were used as comonomers. These monomers differ in polarity, thus enabling control of the polarity of the copolymer. Besides methacrylates, styrene was selected as comonomer with 4-VP, and the introduction of divinylbenzene enables the synthesis of hyperbranched copolymers. Similar reaction conditions were used for all synthetic examples, with 1 molar-% of AIBN radical initiator with respect to the total amount of reactive vinylic groups in the polymerization. Ethanol was used as solvent. Dodecane thiol was used as chain transfer agent in all examples, which may result in the formation of a thioether side product, see also A. R. Katrizky et al., J. Org. Chem., 1986, 51, 4914. Temperatures were around 70° C. Polymers were purified by washing with heptane or petroleum ether.

### Example 1

### Linear Copolymer 10B

4-Vinyl pyridine (7.91 g, 71.43 mmol), 2-hydroxyethyl methacrylate (3.57 ml, 28.57 mmol), n-dodecane thiol (10.33 ml, 42.86 mmol) and AIBN (167 mg, 1 mmol) were dissolved in ethanol (67 ml) in a 3-neck 250 ml round-bottom flask under stirring. The beige, clear solution was purged with argon for 1 h while stirring. A reflux condenser was fitted and the reaction mixture was then stirred and heated at an oil bath temperature of 75° C. for 15 h, and was kept under an argon atmosphere. The solvent was evaporated in vacuo and the orange residual syrup redissolved into ethanol (15 ml) and subsequently precipitated into an ice-cold mixture of heptane (200 ml) and diisopropyl ether (100 ml) during which a beige slurry formed. The slurry was filtered over a glass filter and the residue was washed twice with an ice-cold mixture of heptane (33 ml) and diisopropyl ether (17 ml). Overnight drying of the residue in vacuum yielded the reference linear copolymer 10B as a light-yellow solid (7.19 g, 36%). ¹H-NMR (CDCl₃ and CD₃OD): δ=8.42 (pyridine, broad peak (bp)), 7.08 (pyridine, bp), 4.08 (ester, bp), 3.78 (ester/alcohol, bp), 3.53 (ester/alcohol, bp), 2.5-0.4 (multiple signals, bp), 1.25 (alkyl tail CH₂-groups), 0.88 ppm (triplet (t), ³J (H, H)=6.3 Hz, alkyl tail CH₃-group). FT-IR (ATR): v (cm⁻¹)=3233, 2925, 2854, 1721, 1598, 1558, 1454, 1417, 1386, 1220, 1183, 1145, 1083, 1070, 1026, 1003, 994, 897, 820, 755; GPC (DMF-LiBr): Mn=0.2 kg/mol, Mw=0.3 kg/mol, PDI=1.7; Elemental analysis: C, 67.23; H, 7.88; N, 5.58. Number of pyridine groups as derived from ¹H NMR data: 4.2 mol/kg linear copolymer. T_{g}=39° C.

### Example 2

### Linear Copolymer 22A

4-Vinyl pyridine (11.88 g, 107.1 mmol), methyl methacrylate (4.65 ml, 42.9 mmol), dodecane thiol (15.5 ml, 64.3 mmol) and AIBN (249 mg, 1.5 mmol) were dissolved in ethanol (100 ml) in a 3-neck 250 ml round-bottom flask under stirring. The beige, clear solution was purged with argon for 1 h while stirring. A reflux condenser was fitted and the reaction mixture was heated at an oil bath temperature of 70° C. under argon and stirring for 16 h. The solvent was evaporated in vacuo and the orange residual syrup mixed with heptane (100 ml). This mixture was heated to reflux under stirring to give a beige emulsion. After 0.5 h, the emulsion was allowed to reach room temperature during which time the orange material settled and an orange, clear supernatant formed. The latter was decanted and the residue was mixed with heptane (100 ml) and subsequently heated to 80° C. Stirring of the viscous mixture was performed for 10 minutes after which the mixture was allowed to reach room temperature. An almost colorless, turbid supernatant formed which was decanted and the beige residue was collected, dried under vacuum at room temperature and subsequently mixed with pentane (100 ml) to give a beige suspension upon grinding and stirring. The suspension was allowed to settle, so that a supernatant formed that was then decanted. The residue was collected and dried under vacuum at room temperature in the presence of KOH to give linear copolymer 22A as a beige powder (7.85 g, 27%). ¹H-NMR (CDCl₃): δ=8.46 (pyridine, bp), 6.87 (pyridine, bp), 3.54, 3.35 and 2.91 (ester/alcohol, bp), 2.5-0.4 (multiple bp), 1.24 (alkyl tail CH₂), 0.86 ppm (t, ³J (H, H)=6.1 Hz, alkyl tail CH₃); FT-IR (ATR): v (cm⁻¹)=3423, 3024, 2988, 2925, 2853, 1725, 1597, 1557, 1448, 1416, 1358, 1219, 1196, 1134, 1069, 993, 820, 754; GPC (DMF-LiBr): Mn=0.7 kg/mol, Mw=1.5 kg/mol, PDI=2.1; Elemental analysis: C, 71.74; H, 7.79; N, 7.46. Number of pyridine groups as derived from ¹H NMR data: 5.5 mol/kg linear copolymer. T_{g}=41° C.

### Example 3

### Linear Copolymer 112

4-Vinyl pyridine (6.79 g, 61.3 mmol), styrene (12.85 g, 123 mmol), dodecane thiol (0.160 g, 0.77 mmol) and AIBN (0.308 g, 1.84 mmol) were dissolved in ethanol (60 ml) in a 3-neck 100 ml round-bottom flask under stirring. The beige, clear solution was purged with argon for 2 h while stirring. A reflux condensor was fitted and the reaction mixture was heated at an oil bath temperature of 72° C. under argon and stirring for 26 h. The solvent was evaporated in vacuo and the orange, sticky residue was mixed with heptane (50 ml) in a 100 ml flask and heated at reflux for 2 hours under mechanical stirring. The mixture was allowed to reach room temperature and subsequently the heptane phase was decanted. The resulting beige, sticky residue was dissolved into chloroform (25 ml) and precipitated into well-stirred petroleum ether (250 ml). The petroleum ether phase was decanted and the beige residue dried in a vacuum oven at 30° C. overnight yielding copolymer 112 as a beige, glassy powder (17.8 g, 94%). ¹H-NMR (CDCl₃): δ=8.25 (pyridine, bp), 7.08 (styrene and pyridine, bp), 6.45 (styrene, bp), 2.1-1.0 ppm (multiple bp); FT-IR (ATR): v (cm⁻¹)=3061, 3025, 2921, 2851, 1946, 1870, 1596, 1557, 1493, 1452, 1414, 1373, 1328, 1219, 1182, 1155, 1068, 1028, 993, 907, 819, 756, 698; GPC (DMF-LiBr): Mn=3.5 kg/mol, Mw=10 kg/mol, PDI=2.9; Number of pyridine groups as derived from ¹H NMR data: 3.5 mol/kg linear copolymer. The copolymer has a glass transition temperature between 60 and 80. T_{g}=76° C. The yield of the copolymer reaction was 94%.

### Example 4

### Hyperbranched Copolymer 116

4-Vinyl pyridine (7.06 g, 63.8 mmol), styrene (13.21 g, 126 mmol), dodecane thiol (12.95 g, 62.7 mmol), divinylbenzene (0.945 g, 6.2 mmol) and AIBN (0.339 g, 2.0 mmol) were dissolved in ethanol (69 ml) in a 3-neck 250 ml round-bottom flask under stirring. The beige, clear solution was purged with argon for 1 h while stirring. A reflux condensor was fitted and the reaction mixture was heated at an oil bath temperature of 71° C. under argon and stirring for 25 h. The solvent was evaporated in vacuo and the brownish, sticky, viscous syrup was mixed with petroleum ether (150 ml) in a 250 ml flask after which immediately a beige, sticky precipitate formed. The petroleum ether phase was decanted and the beige, sticky residue was mixed with petroleum ether (100 ml) and heated at reflux (oil bath=100° C.) for 1 hour. Manual stirring with a spatula was applied. The mixture was allowed to reach room temperature and subsequently the petroleum ether phase was decanted. The resulting beige, sticky residue was mixed with petroleum ether (100 ml) and heated at reflux (oil bath=105° C.) for 1 hour. Manual stirring with a spatula was applied. The mixture was allowed to reach room temperature and subsequently the petroleum ether phase was decanted. The beige residue was dried in a vacuum oven at 60° C. overnight yielding copolymer 116 as a beige, glassy powder (6.2 g, 19%). ¹H-NMR (CDCl₃): δ=8.24 (pyridine, bp), 7.08 (styrene and pyridine, bp), 6.50 (styrene, bp), 2.7-1.0 (multiple bp), 1.26 (alkyl tail CH₂), 0.88 ppm (triplet (t), ³J (H, H)=6.2 Hz, alkyl tail CH₃-group); FT-IR (ATR): v (cm⁻¹)=3060, 3025, 2922, 2852, 1946, 1873, 1804, 1596, 1557, 1492, 1452, 1414, 1369, 1328, 1219, 1181, 1155, 1068, 1023, 993, 907, 820, 757, 697; GPC (DMF-LiBr): Mn=1.1 kg/mol, Mw=7.3 kg/mol, PDI=6.8; Number of pyridine groups as derived from ¹H NMR data: 2.4 mol/kg hyperbranched copolymer. T_{g}=67° C. The yield of the copolymer reaction was 19%.

The relative molar amounts of the quaternizable monomer 4-vinyl pyridine, the comonomer and reactants that were used in Examples 1-4 are compiled in Table 1. Table 1 also contains the molar composition of the product copolymers, which was determined by ¹H-NMR spectroscopy.

TABLE 1
Applied molar compositions of the reaction mixtures
and molar compositions of the isolated copolymers.

| Example | | | | | | | dodeca- |
|---|---|---|---|---|---|---|---|
| Entry | | 4-VP | HEMA | MMA | styrene | DVB | nethiol |
| | | Applied molar ratio of the monomers | | | | | |
| | | in the reaction mixture | | | | | |
| 1 | 10B | 25 | 10 | — | — | — | 15 |
| 2 | 22A | 25 | — | 10 | — | — | 15 |
| 3 | 112 | 10 | — | — | 20 | — | 0.12 |
| 4 | 116 | 10 | — | — | 20 | 1 | 10 |
| | | Molar ratio of the monomeric units | | | | | |
| | | in the copolymers | | | | | |
| 1 | 10B | 10 | 6.7 | — | — | — | 2.1 |
| 2 | 22A | 10 | — | 4.8 | — | — | 1.4 |
| 3 | 112 | 10 | — | — | 17 | — | 0 |
| 4 | 116 | 10 | — | — | 25 | ? | 2.7 |

Note:
The amount of DVB in polymer 116 could not be derived from its ¹H-NMR data. The amount of AIBN was always 1 mol-% compared to vinyl groups (note that DVB possesses two vinyl groups). Abbreviations are explained in Schemes 1 and 2.

### Membrane Preparation

Poly(4-vinyl pyridine-co-styrene) linear copolymer 112 from example 3 was received as a dry powder. The polymer ratio between 4-vinyl pyridine and styrene was 1:1.63. Copolymer was dissolved in N-butyl acetate (Sigma-Aldrich) to obtain 45% (by weight) solution. Membranes can be crosslinked by using dihalides (alkyl, alkenyl, alkynyl and aryl dihalides).

P(4-VPcS) was tested with 1,6-diiodohexane, 1,5-dibromopentane, 1,6-dibromohexane and 1,10-dibromodecane. To activate ion exchange groups without crosslinking monohalides can be used. For pilot experiments 1,6 diiodohexane was chosen. Amount of 1,6-diiodohexane (98% stabilized with copper, Alfa Aesar) was added in order to achieve 100% crosslinking, solution was mixed for 6 minutes after the crosslinker was added. Membranes were casted on a glass plate. For full scale experiments they were casted with a thickness set on applicator to 120 μm. Casting was performed by automatic applicator (Zehnter ZAA 2300, speed set to 1 mm/s). Casted films were dried in the oven for 24 h at approximately 50° C. then soaked off the glass plates, put into 0.05M KCl solution for 4 days (to let membranes swell and exchange counter-ions). Next step was to cut membranes to proper dimension (16×16 cm) in order to put them in the CapDI system. Subsequently membranes were tested in full scale stack at CC for 3 days. Before and after constant current test small samples of the membranes were taken to characterize them (resistance, permselectivity, swelling and IEC).

### Calculations of Amount of Crosslinker and Theoretical IEC

$$Amount of crosslinker = E = \frac{A * \frac{B}{100} * C * \frac{D}{200} * Mw 1}{1000}$$

$${IEC}_{theoretical} = \frac{A * B * C}{A * B + E - F} = 2.62 \frac{mmol}{g}$$

Where:

A=Amount of polymer solution [g];

B=Polymer concentration [%];

C=Pyridine groups per gram of dry polymer [mmol/g];

D=Crosslinking percentage [%];

E=Amount of crosslinker [g];

F=Counter ion weight correction (NO₃⁻ form) [g];

Mw1=Molar weight of crosslinker (337.97, 1,6 Diiodohexane).

### P(4-VPcS) Membrane Performance as a Function of Membrane Thickness

Membrane resistance was measured at 2M NaCl by direct current method and permselectivity was measured by membrane potential method (0.5M/0.05M KCl). IEC capacity was measure by exchanging counter ions. All methods are described in more details in Piotr Dlugolecki et. al. Journal of Membrane Science 319 (2008) 214-222.

Membrane thickness was investigated in order to evaluate influence on the membrane resistance, membrane selectivity and membrane mechanical stability.

TABLE 1
Membrane performance as a function of membrane film thickness

| Casting | Wet | | |
|---|---|---|---|
| thickness | thickness | Resistance | Selectivity |
| [μm] | [μm] | [Ω · cm²] | [%] |
| 60 | 19 | 1.00 | 97.8 |
| 90 | 25 | 1.22 | 97.4 |
| 120 | 41 | 1.51 | 98.2 |
| 180 | 59 | 2.12 | 98.4 |
| 240 | 68 | 2.56 | 97.9 |

P(4-VPcS) membrane resistance is a function of membrane thickness. The lowest resistance values were achieved for 60 and 90 microns casted samples. Selectivity for all samples thickness remains stable. For comparison, the data with respect to example 4 hyperbranched copolymer 116 are depicted below. The electrical resistance is much higher than the linear copolymer 112, making the linear copolymer desirable.

Hyperbranched copolymer 116 (pyridine:styrene 1:2.5)

| | | |
|---|---|---|
| Pyridine content | | 2.4 mmol/g |
| Resistance (non-woven) | 120 μm | 88 Ω · cm2 |
| | 180 μm | 136 Ω · cm2 |
| Selectivity | | 97% |
| Theoretical IEC | | 1.92 meq/g |

### Different Dihalocarbons (Dihalo-Alkanes) Crosslinker Investigation.

Different dihalo-ahalkanes e.g. dihalides crosslinkers such as 1,6-diiodohexane, 1,5-dibromopentane, 1,6-dibromohexane and 1,10 dibromodecane were investigated. Casted membrane thickness was set to 120 microns.

Membrane performance with these crosslinkers were investigated.

| | Resistance | | |
|---|---|---|---|
| Crosslinker | [Ω · cm²] | Selectivity [%] | IEC [mmol/g] |
| 1,6-Diiodohexane | 1.48 | 97.1 | 2.22 |
| 1,6-Dibromohexane | 1.96 | 97.5 | 2.48 |
| 1,10-Dibromodecane | 2.15 | 97.6 | 2.42 |
| 1,5-Dibromopentane | 2.82 | 97.3 | 2.67 |

For all samples selectivity was similar, but resistance values differ. Different crosslinkers have different boiling points and vapor pressure and also influence IEC of the membrane at different levels. Moreover, longer molecules change polarity of membranes and the distance between ion exchange groups. 1,6-diiodohexane and 1,6-dibromohexane show similar performance. Membrane resistance is lower for 1,6-diiodohexane, but also IEC is lower, which provides less interaction between counter ion and fixed charges in the membrane matrix. 1,10-dibromodecane is very comparable with 1,6-diiodohexane with respect to all performance. 1,5-dibromopentane has the highest resistance and highest IEC. This effect is partly related with lower intermolecular distance and higher ion exchange capacity.

Anion exchange membranes (AEM's) were cast from P(4-VPcS) copolymer and were crosslinked with 1,6 diiodohexane. P(4-VPcS) AEM membranes with a thickness of 40 micrometers were used to build a capacitive deionization module with 18 cells, where a cell has two electrodes, two current collectors, two membranes and a spacer. In one stack P(4-VPcS) AEM membranes were used and in another stack Neosepta CMX membranes. The cation exchange membrane was in both cases Neosepta CMX. The feed water in these experiments was made according to NSF 44 with a conductivity of 940 μS/cm. All experiments were done at room temperature with a flow of 1.2 l/min/m² of spacer area. The operational cycle was 5 seconds of pre-desalination, followed by 175 seconds of desalination and 90 seconds of electrode regeneration. The experiments were performed with a set current of 5.5 A and 11 A during desalination and regeneration respectively.

Vinyl Pyridine-Styrene Anion Exchange Membrane Performance

| | Resistance | Selectivity | IEC | Water uptake |
|---|---|---|---|---|
| Sample No. | [Ω · cm²] | [%] | [mmol/g] | [%] |
| 1 | 0.68 | 97.5 | 2.14 | 44 |
| 2 | 0.76 | 97.9 | 2.14 | 44 |
| 3 | 1.01 | 97.5 | 2.13 | 54 |
| 4 | 2.19 | 97.4 | | |
| Average | 1.16 | 97.6 | 2.14 | 47 |

The membranes have a good performance. Selectivity for all samples is above 97%. Difference in resistance between samples might be explained by variation in membrane thickness (from 38 to 84 μm). Ion exchange capacity of 2.14 mmol/g corresponds to 82% of group activation (2.14/2.62·100%).

The voltage (V) profile versus time (s) was measured after 4 h of constant current operation (FIG. 4) and shows that voltage (V) during water desalination (desal) for P(4-VPcS) membranes is significantly lower than for the reference (Ref) membrane. P(4-VPcS) membranes have lower resistance than the reference membrane and will result in lower end voltage of the system. Moreover, electrode regeneration (Reg) is more complete due to fact that P(4-VPcS) membranes operate longer on constant current (later reaching the voltage limit).

Membranes Performance after the Test

After 3 days, the test membrane permselectivity and resistance was measured

| Sample | Resistance | Selectivity | IEC | Wateruptake | Thickness |
|---|---|---|---|---|---|
| No. | [Ω · cm²] | [%] | [mmol/g] | [%] | [μm] |
| 1^{st} | 0.77 | 96.7 | 2.16 | 23 | 71 |
| 5^{th} | 0.71 | 96.9 | 2.26 | 33 | 83 |
| 10^{th} | 0.99 | 96.7 | 2.29 | 39 | 68 |
| 14^{th} | 0.42 | 96.5 | 2.27 | 52 | 68 |

After the tests, P(4-VPcS) membrane resistance seems to be on the same level as before the test. Membrane permselectivity and ion exchange capacity remained also at the same level.

P(4-VPcS) anion exchange membranes have a high selectivity for anions and at the same time a low resistance for ion transport. Moreover, the vinyl pyridine-styrene film is mechanically strong and therefore no additional reinforcement may be needed. These membranes show potential for capacitive deionization systems, but they may also be applied in various ion exchange processes.

In an embodiment, an anion exchange membrane with anion exchange groups may be prepared by a method comprising:
reacting at least a first monomer comprising a benzene derivative with a second monomer comprising a benzene derivative with a halide group to form a copolymer; and
reacting the pyridine derivative of a crosslinker comprising at least a first pyridine derivative group to the copolymer, with the copolymer to crosslink the copolymer and at the same time to at least partially functionalize the pyridine derivative to form an anion exchange group.

The first and second monomer may comprise a vinyl group and forming the copolymer may comprise providing an initiator and a chain transfer agent to react the vinyl groups with each other to polymerize the copolymer. The crosslinker may comprise two pyridine derivative groups which may crosslink the copolymers and may be functionalized to anion exchange groups.

There is further provided the use of a crosslinked copolymer with ion exchange groups as described herein, an ion exchange membrane as described herein, or an apparatus as described herein, for the removal of ions from water.

These and other aspects, features and advantages will become apparent to those of ordinary skill in the art from reading the description and the appended claims. For the avoidance of doubt, any feature of one aspect of the present invention may be utilized in any other aspect of the invention. It is noted that the examples given in the description below are intended to clarify the invention and are not intended to limit the invention to those examples per se. Similarly, all percentages are weight/weight percentages unless otherwise indicated. Numerical ranges expressed in the format “from x to y” or “x-y” are understood to include x and y. When for a specific feature multiple preferred ranges are described in the format “from x to y”, it is understood that all ranges combining the different endpoints are also contemplated.

1. A method of preparing an anion exchange membrane with anion exchange groups, the method comprising:
reacting at least a first monomer comprising vinyl-pyridine with a pyridine derivative as a functional group with at least a second monomer comprising styrene to form a substantial linear copolymer; and
reacting the substantially linear copolymer with a crosslinker, the crosslinker reacting with the pyridine derivative group of the substantially linear copolymer crosslinking the substantially linear copolymer and forming the anion exchange groups.

2. The method according to claim 1, wherein the molar ratio of the first monomer to the second monomer is 1:1 to 4.

3. The method according to claim 1, wherein each of the first and second monomers comprise a vinyl group and the reacting step to form a copolymer comprises using an initiator and a chain transfer agent to react the vinyl groups with each other.

4. The method according to claim 3, wherein the chain transfer agent comprises a thiol group.

5. The method according to claim 3, wherein the first and second monomers and the chain transfer agent are provided in a molar ratio of from 1:1 to 4:0.005 to 0.03 to form the copolymer.

6. The method according to claim 1, wherein the crosslinker is a compound of the group of dihalocarbons.

7. The method according to claim 6, wherein the dihalocarbon is a dihalo-alkane selected from: 1,6-diiodohexane, 1,5-diodobromopentane, 1,6-dibromohexane and/or 1,10-dibromodecane.

8. The method according to claim 1, wherein the anion exchange groups are formed by reacting the copolymer and/or the crosslinked polymer with a monohalocarbon before and/or during the reacting step of the copolymer with the crosslinker.

9. The method according to claim 1, wherein the anion exchange groups are formed by a quaternization reaction between the pyridine derivative and a monohalide and/or dihalide.

10. The method according to claim 1, wherein the reaction of the copolymer with the crosslinker is carried out at least partially on a surface of a first electrode.

11. The method according to claim 1, wherein the first monomer comprises at least one monomer selected from the following: 4-vinylpyridine; 3-vinylpyridine; 2-vinylpyridine; 2-methyl-5-vinylpyridine; and/or 5-ethyl-2-vinylpyridine.

12. The method according to claim 1, wherein the second monomer comprises an apolar or polar styrene derivate.

13. The method according to claim 1, wherein the second monomer comprises at least one monomer selected from the following: 4-tert-butoxystyrene; 2,4-dimethylstyrene; 2,5-dimethylstyrene; 3-methylstyrene; 4-methylstyrene; 2,4,6-trimethylstyrene 3,4-dimethoxystyrene; 4-methoxystyrene; 3-hydroxystyrene; 4-hydroxystyrene and/or 4-acetoxystyrene.

14. The method according to claim 1, wherein the number of pyridine groups as derived from H NMR data is between 1 to 5 Mol/Kg copolymer and/or the number average molecular weight (Mn) of the copolymer is between 2 and 5 Kg/mol and the weight average molecular weight (Mw) of the copolymer is between 7 and 15 Kg/mol.

15. An apparatus for removal of ions, the apparatus being provided with:
a first and second electrode; and
an anion exchange membrane on the first electrode, wherein the anion exchange membrane is obtained by crosslinking a substantially linear copolymer according to the method of claim 1.
